(19) United States
(12) Patent Application Publication
(10) Pub. No.: US 2026/0298688 A1
(43) Pub. Date: Oct. 1, 2026

(54) TEMPERATURE-BASED LEVEL GAUGE FOR A VESSEL

(71) Applicant: VOLVO TRUCK CORPORATION, Göteborg (SE)

(72) Inventors: Anton HAGBY, Göteborg (SE); Sigurd SONDEREGGER, Askim (SE)

(73) Assignee: VOLVO TRUCK CORPORATION, Göteborg (SE)

(21) Appl. No.: 19/476,867

(22) PCT Filed: Apr. 18, 2023
(86) PCT No.: PCT/IB2023/053976

§ 371 Date: Oct. 20, 2025

(51) Int. Cl. G01F 23/22

(52) U.S. Cl. CPC G01F 23/22

(57) ABSTRACT

A temperature-based level gauge for a vessel includes a plurality of temperature sensors disposed spaced apart along a height of a surface of a wall of the vessel, each of the plurality of temperature sensors being configured to measure a surface temperature of the vessel at a 5 height location along the surface of the wall of the vessel and to output a signal representative of the surface temperature; and a controller in communication with the plurality of temperature sensors, the controller being configured to receive the signal representative of the surface temperature from the plurality of temperature sensors. The controller is configured to determine a level of a liquid inside the vessel based on the surface temperatures measured by 0 the plurality of temperature sensors.

### TECHNICAL FIELD

The disclosure relates generally to fluid level gauges. In particular aspects, the disclosure relates to a temperature-based level gauge for a vessel. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Many methods can be used to measure a level of a liquid in a tank or vessel. For example, the existing method of reading fuel level in a diesel fuel tank uses a floater. However, this method is inadequate for cryogenic application since the cold temperature would make parts brittle. In addition, at the low temperatures found in cryogen applications, moving parts do not operate smoothly. Other methods of measuring a level of a fluid in a tank require a vertical free passage inside the tank for equipment to be inserted in. Further methods used in cryogen applications are based on the electrical capacitance where the resistance between a sender and a receiver is measured. However, the low temperatures in cryogenic applications inside the tank make for a challenging environment for electrical components. Other methods use radar-based measuring systems. However, the radar-based measuring systems are also mounted inside the tanks.

### SUMMARY

According to a first aspect of the disclosure, a temperature-based level gauge for a vessel, includes: (a) a plurality of temperature sensors disposed spaced apart along a height of a surface of a wall of the vessel, each of the plurality of temperature sensors being configured to measure a surface temperature of the vessel at a height location along the surface of the wall of the vessel and to output a signal representative of the surface temperature; and (b) a controller in communication with the plurality of temperature sensors, the controller being configured to receive the signal representative of the surface temperature from the plurality of temperature sensors. The controller is configured to determine a level of liquid inside the vessel based on the surface temperatures measured by the plurality of temperature sensors.

The first aspect of the disclosure may seek to read the fuel level from the outside of the tank. A technical benefit may include facilitating a less harsh environment for the measuring equipment with the ability of providing access for service. The method can be used independently of the internal geometry of the tank.

In some examples, including in at least one preferred example, optionally, the plurality of temperature sensors are disposed spaced apart along a height of an exterior surface of the wall of the vessel, opposite an interior surface of the wall that is in contact with a liquid within the vessel. A technical benefit may include accessibility to the plurality of temperature sensors for servicing and providing temperature measurement at spaced apart locations along the height of an exterior surface of the wall of the vessel.

In some examples, including in at least one preferred example, optionally, the plurality of temperature sensors comprises a plurality of first temperature sensors disposed along a height of a first surface of the wall of the vessel, and a plurality of second temperature sensors disposed along a height of a second surface of the wall of the vessel. The second surface is opposite to the first surface so as to take into consideration a sloshing of the liquid inside the vessel. A technical benefit may include taking into consideration a sloshing of the liquid inside the vessel, for example during a motion of a vehicle carrying the vessel.

In some examples, including in at least one preferred example, optionally, the plurality of temperature sensors are regularly spaced apart along the height of the surface of the wall of the vessel. A technical benefit may include increasing a precision of measurement of the temperature at the regularly spaced locations along the height of the surface of the wall of the vessel.

In some examples, including in at least one preferred example, optionally, a spacing between two successive temperature sensors is selected according to a desired precision in determining a level of liquid inside the vessel. A technical benefit may include controlling the precision of measurement of the temperature at the regularly spaced locations along the height of the surface of the wall of the vessel.

In some examples, including in at least one preferred example, optionally, the vessel is a double-walled vessel and the plurality of temperature sensors are disposed spaced apart along the height of a surface of an interior wall of the double-walled vessel. A technical benefit may include insulating a cavity of the vessel carrying the fluid from the outside environment while providing measurement locations along the height of a surface of an interior wall of the double-walled vessel.

In some examples, including in at least one preferred example, optionally, the wall of the vessel has a round cross-section and the plurality of temperature sensors are disposed spaced apart along a perimeter of the surface of the wall having the round cross-section. A technical benefit may include using the plurality of temperature sensors for any shape of the vessel including a wall of the vessel having a round cross-section.

In some examples, including in at least one preferred example, optionally, the controller is in communication with the plurality of temperature sensors using electrical wires or the controller is in communication with the plurality of temperature sensors wirelessly. A technical benefit may include providing various options for communication between the plurality of temperature sensors and the controller.

In some examples, including in at least one preferred example, optionally, wherein the controller is configured to determine the level of the liquid inside the vessel by i) determining a first temperature at a first height on the surface of the wall where liquid is present to provide a first data point, ii) determining a second temperature at a second height on the surface of the wall where gas is present to provide a second data point, and iii) determining the level of the liquid inside the vessel by interpolating the first data point and the second data point. A technical benefit may include using an interpolation technique that provides a relatively precise location of the level of the liquid based on a relationship between the height and temperature.

In some examples, including in at least one preferred example, optionally, wherein the controller is configured to determine a level of the liquid inside the vessel based on a relationship between the height where the plurality of sensors are located and the temperature measured by the plurality of temperature sensors. A technical benefit may include using a relationship between the height and temperature to determine a level of the liquid inside the vessel.

According to a second aspect of the disclosure, a vehicle includes a cabin having a dashboard instrument cluster indicator; a vessel configured to carry a liquid; and a temperature-based level gauge. The temperature-based level gauge includes a plurality of temperature sensors disposed spaced apart along a height of a surface of a wall of the vessel, each of the plurality of temperature sensors being configured to measure a surface temperature of the vessel at a height location along the surface of the wall of the vessel and to output an electrical signal representative of the surface temperature; and a controller in communication with the plurality of temperature sensors and the dashboard instrument cluster indicator, the controller being configured to receive the electrical signal representative of the surface temperature from each of the plurality of temperature sensors. The controller is configured to determine a level of the liquid inside the vessel based on surface temperatures measured by the plurality of temperature sensors. The second aspect of the disclosure may seek to measure a level of a liquid in a vessel carried by the vehicle and allowing, for example, the conductor or driver of the vehicle to monitor the level of liquid during transport.

In some examples, including in at least one preferred example, optionally, the plurality of temperature sensors are disposed spaced apart along a height of an exterior surface of the wall of the vessel, opposite an interior surface of the wall that is in contact with a liquid within the vessel.

In some examples, including in at least one preferred example, optionally, the plurality of temperature sensors comprise a plurality of first temperature sensors disposed along a height of a first surface of the wall of the vessel, and a plurality of second temperature sensors disposed along a height of a second surface of the wall of the vessel, wherein the first surface is opposite to the first surface so as to take into consideration a sloshing of the liquid inside the vessel.

In some examples, including in at least one preferred example, optionally, the plurality of temperature sensors are regularly spaced apart along the height of the surface of the wall of the vessel.

In some examples, including in at least one preferred example, optionally, a spacing between two successive temperature sensors is selected according to a desired precision in determining a level of liquid inside the vessel.

In some examples, including in at least one preferred example, optionally, the vessel is a double-walled vessel and the plurality of temperature sensors are disposed spaced apart along the height of a surface of an interior wall of the double-walled vessel.

In some examples, including in at least one preferred example, optionally, the vessel is a double-walled vessel and the plurality of temperature sensors are disposed spaced apart along the height of a surface of an exterior wall of the double-walled vessel.

In some examples, including in at least one preferred example, optionally, the wall of the vessel has a round cross-section and the plurality of temperature sensors are disposed spaced apart along a perimeter of the surface of the wall having the round cross-section.

In some examples, including in at least one preferred example, optionally, the controller is in communication with the plurality of temperature sensors using electrical wires or the controller is in communication with the plurality of temperature sensors wirelessly.

In some examples, including in at least one preferred example, optionally, the controller is configured to determine the level of the liquid inside the vessel by i) determining a first temperature at a first height on the surface of the wall where liquid is present to provide a first data point, ii) determining a second temperature at a second height on the surface of the wall where gas is present to provide a second data point, and iii) determining the level of the liquid inside the vessel by interpolating the first data point and the second data point.

In some examples, including in at least one preferred example, optionally, wherein the controller is configured to determine a level of the liquid inside the vessel based on a relationship between the height where the plurality of sensors are located and the temperature measured by the plurality of temperature sensors.

According to a third aspect of the disclosure, a method of measuring a level of a liquid in a vessel includes providing a plurality of temperature sensors disposed spaced apart along a height of a surface of a wall of the vessel; providing a controller in communication with the plurality of temperature sensors; measuring, with each of the plurality of temperature sensors, a surface temperature of the vessel at a height location along the surface of the wall of the vessel; outputting a signal representative of the surface temperature; receiving, by the controller, the signal representative of the surface temperature from each of the plurality of temperature sensors; and determining, by the controller, a level of liquid inside the vessel based on a variation of surface temperatures measured by the plurality of temperature sensors. The third aspect of the disclosure may seek to measure a level of a liquid in a vessel carried by the vehicle and allowing, for example, the conductor or driver of the vehicle to monitor the level of liquid during transport.

In some examples, including in at least one preferred example, optionally, providing the plurality of temperature sensors disposed spaced apart along the height of the surface of the wall of the vessel comprises disposing the plurality of temperature sensors spaced apart along a height of an exterior surface of the wall of the vessel opposite an interior surface of the wall that is in contact with a liquid inside the vessel.

In some examples, including in at least one preferred example, optionally, providing the plurality of temperature sensors disposed spaced apart along the height of the surface of the wall of the vessel comprises disposing the plurality of temperature sensors on opposite sides on the surface of the wall of the vessel so as to take into consideration a sloshing of the liquid inside the vessel.

In some examples, including in at least one preferred example, optionally, providing the plurality of temperature sensors disposed spaced apart along the height of the surface of the wall of the vessel comprises disposing the plurality of temperature sensors spaced apart regularly along the height of a surface of the wall of the vessel.

In some examples, including in at least one preferred example, optionally, providing the plurality of temperature sensors disposed spaced apart along the height of the surface of the wall of the vessel comprises disposing the plurality of temperature sensors spaced apart along the height of a surface of an inside wall of a double-walled vessel.

In some examples, including in at least one preferred example, optionally, providing the plurality of temperature sensors disposed spaced apart along the height of the surface of the wall of the vessel comprises disposing the plurality of temperature sensors spaced apart along the height of a surface of an exterior wall of a double-walled vessel.

In some examples, including in at least one preferred example, optionally, the wall of the vessel has a round cross-section and the plurality of temperature sensors are disposed spaced apart along a perimeter of the surface of the wall having the round cross-section.

In some examples, including in at least one preferred example, optionally, further including: determining a first temperature corresponding to a temperature of a first height on the wall where the liquid is present to provide a first data point; determining a second temperature corresponding to a temperature of a second height on the wall where a gas is present to provide a second data point; and determining the level of the liquid inside the vessel by interpolating the first data point and the second data point.

In some examples, including in at least one preferred example, optionally, the plurality of temperature sensors includes a first set of temperature sensors disposed spaced apart along the height of the surface of a wall of the vessel and a second set of temperature sensors disposed spaced apart along the height of the surface of another wall of the vessel and spaced apart from the first set temperature sensors.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is a schematic diagram of an exemplary temperature-based level gauge for a vessel, according to an example.

FIG. 2 is a schematic diagram of an exemplary double-walled vessel, according to an example.

FIG. 3 is a schematic diagram of an exemplary vessel having a wall with a round cross-section, according to an example.

FIG. 4A is a schematic diagram of the vessel having the plurality of temperature sensors, according to an example.

FIG. 4B is an exemplary points and graph of height versus temperature captured by the plurality of temperature sensors 104, according to an example.

FIG. 5 is a schematic diagram of an exemplary vehicle configured to carry the vessel, according to an example.

FIG. 6 is a schematic diagram of an exemplary computer system for implementing examples disclosed herein, according to an example.

FIG. 7A is a schematic diagram of the vessel having q plurality of spaced apart temperature sensors for measuring temperature at different heights along a wall of the vessel to take into consideration a sloshing effect of a liquid inside the vessel, according to an example.

FIG. 7B is an exemplary points and graph of height versus temperature captured by the plurality of temperature sensors, according to an example.

### DETAILED DESCRIPTION

The detailed description set forth below provides information and examples of the disclosed technology with sufficient detail to enable those skilled in the art to practice the disclosure.

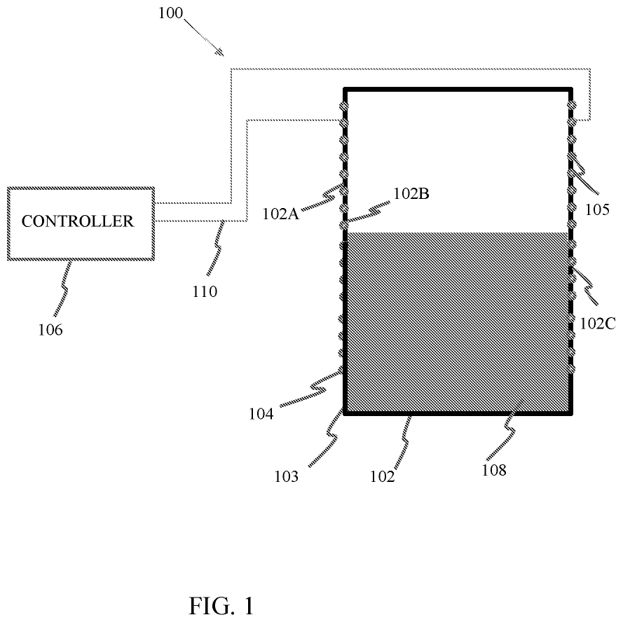

FIG. 1 is a schematic diagram of an exemplary temperature-based level gauge 100 for a vessel 102, according to an example. The temperature-based level gauge 100 includes a plurality of temperature sensors 104 and 105 disposed spaced apart along a height of a surface 102A of a wall 103 of the vessel 102. Each of the plurality of temperature sensors 104 is configured to measure a surface temperature of the vessel 102 at a height location along the surface 102A of the wall 103 of the vessel 102 and to output a signal representative of the surface temperature. The temperature-based level gauge 100 further includes a controller 106 in communication with the plurality of temperature sensors 104. The controller 106 is configured to receive the signal representative of the surface temperature from the plurality of temperature sensors 104. The controller 106 is configured to determine a level of liquid 108 inside the vessel 102 based on the surface temperatures measured by the plurality of temperature sensors 104.

In some examples, including in at least one preferred example, optionally, the controller 106 is in communication with the plurality of temperature sensors 104 and/or 105 using electrical wires 110 or the controller 106 is in communication with the plurality of temperature sensors 104 and/or 105 wirelessly. A technical benefit may include providing various options for communication between the plurality of temperature sensors 104 and the controller 106.

The level of liquid 108 can be measured from the outside of the vessel 102. A technical benefit may include facilitating a less harsh environment for the measuring equipment, including the plurality of temperature sensors 104, with the ability of providing access for service. The plurality of temperature sensors 104 can be easily accessed for service if needed.

In some examples, including in at least one preferred example, optionally, the plurality of temperature sensors 104 are disposed spaced apart along a height of an exterior surface 102A of the wall 103 of the vessel 102, opposite an interior surface 102B of the wall 103 that is in contact with the liquid 108 within the vessel 102. A technical benefit may include accessibility to the plurality of temperature sensors 104 for servicing and providing temperature measurement at spaced apart locations along the height of the exterior surface 102A of the wall 103 of the vessel 102.

In some examples, including in at least one preferred example, optionally, the plurality of temperature sensors 104 include the plurality of first temperature sensors 104 disposed along a height of a first surface 102A of the wall 103 of the vessel 102, and the plurality of second temperature sensors 105 disposed along a height of a second surface 102C of the wall 103 of the vessel 102. The second surface 102C is opposite to the first surface 102A so as to take into consideration a sloshing of the liquid 108 inside the vessel 102. A technical benefit may include taking into consideration the sloshing of the liquid 108 inside the vessel 102, for example, during a motion of a vehicle carrying the vessel 102. The sloshing is an irregular or back and forth movement of the liquid 108 against the wall 103 of the vessel 102. The sloshing may occur, for example, during the travel of the vehicle carrying the vessel 102 on an uneven road or during turns.

In some examples, including in at least one preferred example, optionally, the plurality of temperature sensors 104 are regularly spaced apart along the height of the surface 102A and/or 102C of the wall 103 of the vessel 102, as shown in FIG. 1. A technical benefit may include increasing a precision of measurement of the temperature at the regularly spaced locations along the height of the surface of the wall 103 of the vessel 102.

In some examples, including in at least one preferred example, optionally, a spacing between two successive temperature sensors in the plurality of temperature sensors 104 is selected according to a desired precision in determining a level of liquid 108 inside the vessel 102. A technical benefit may include controlling the precision of measurement of the temperature at the regularly spaced locations along the height of the surface of the wall of the vessel. For example, the smaller the spacing between adjacent temperature sensors in the plurality of sensors, the higher is the precision of the measurement of the temperature and thus by extension of the higher is the precision of the measurement of the level of liquid 108 within the vessel 102.

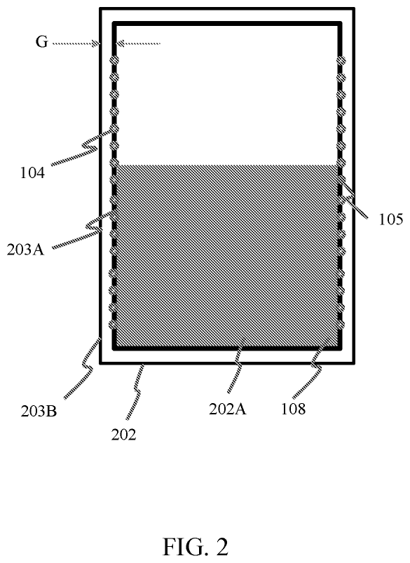

FIG. 2 is a schematic diagram of an exemplary double-walled vessel 202, according to an example. In some examples, including in at least one preferred example, optionally, the vessel 202 is a double-walled vessel. The double-walled vessel 202 has an interior wall 203A and an exterior wall 203B. The plurality of temperature sensors 104 and 105 are disposed spaced apart along the height of a surface of the interior wall 203A of the double-walled vessel 202. A technical benefit may include providing a gap or spacing G between the interior wall 203A and the exterior wall 203B so as to insulate a cavity 202A of the vessel 202 carrying the liquid 108 from the outside environment while providing measurement locations along the height of a surface of an interior wall of the double-walled vessel 202. The gap or spacing G between the interior wall 203A and the exterior wall 203B can be provided with a vacuum so as to reduce a thermal conductivity between the interior wall 203A which is in contact with the liquid at low temperature (cryogenic liquid) and the exterior wall 203B which is in contact with the environment at ambient temperature. Other materials, such as insulating materials, may also be provided in gap G.

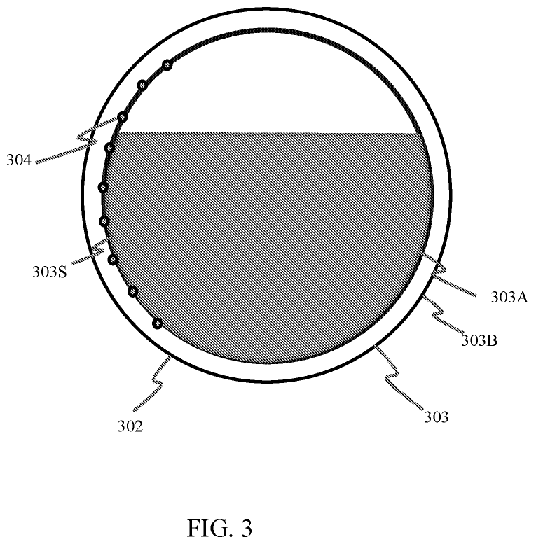

FIG. 3 is a schematic diagram of an exemplary vessel 302 having a wall 303 with a round cross-section, according to an example. For example, as shown in FIG. 3, the vessel 302 is a double-walled vessel 302. The wall 303 of the vessel 302 includes an interior wall 303A and an exterior wall 303B. As shown in FIG. 3, both the interior wall 303A and the exterior wall 303B have a round cross-section, for example, a circular cross-section. However, the interior wall 303A can have a round cross-section while the exterior wall 302B can have any other cross section, such as a polygonal cross-section. The interior wall 303A can also have a polygonal cross-section while the exterior wall can have a round cross-section, for example, a circular cross-section. In some examples, including in at least one preferred example, optionally, the wall 303 (including the interior wall 303A and/or the exterior wall 303B) of the vessel 302 can have a round cross-section and the plurality of temperature sensors 304 are disposed spaced apart along a perimeter of the surface 303S of the interior wall 303A having the round cross-section. A technical benefit may include using the plurality of temperature sensors 304 for any shape of the wall 303 of the vessel 302.

In some examples in which the vessel include a plurality of walls, the temperature sensors may be placed on any of the wall surfaces. For example, in the example embodiment of FIG. 3, the temperature sensors 304 may be placed on an inside or outside of interior wall 303A, exterior wall 303B, and/or one or more surfaces. Further, the temperature sensors may be placed at various locations along the length and/or height of the vessel. This may vary based on the vessels size and shape.

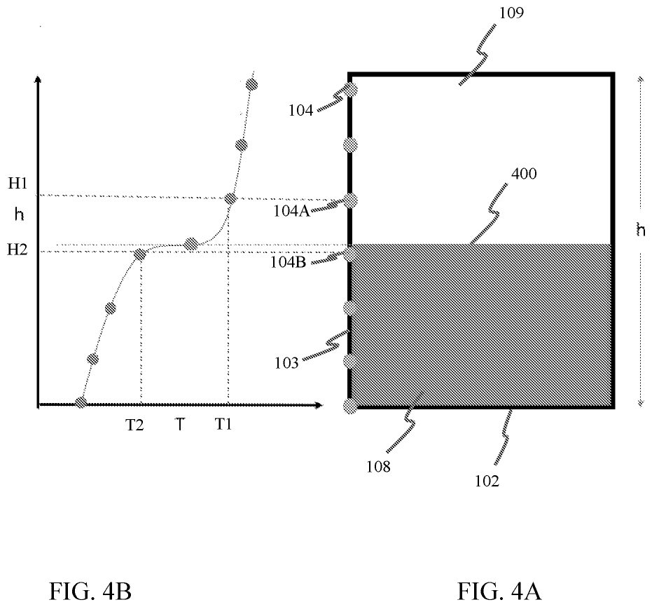

FIG. 4A is a schematic diagram of the vessel 102 having the plurality of temperature sensors 104, according to an example. FIG. 4B is an exemplary points and graph of height versus temperature captured by the plurality of temperature sensors 104, according to an example. Each of the plurality of temperature sensors 104 is positioned at a known height on the wall 103 of the vessel 102. Each of the plurality of temperature sensors captures or detects a temperature at the height location on the wall 103 of the vessel 102. For example, a first temperature sensor 104A at a first height H1 detects or captures a first temperature T1 and second temperature sensor at a second height H2 detects or captures a second temperature T2. The temperatures detected by the plurality of temperature sensors 104 and corresponding height positions of the plurality of temperature sensors 104 are recorded in a table and/or plotted, as shown in FIG. 4B. In some examples, including in at least one preferred example, optionally, the controller 106 (shown in FIG. 1) in communication with the plurality of temperature sensors 104 is configured to determine a level of the liquid 108 inside the vessel 102 based on a relationship between the height H where the plurality of temperature sensors 104 are located and the temperature T measured by the plurality of temperature sensors 104. A technical benefit may include using the relationship between the height and temperature to determine a level of the liquid inside the vessel. The relationship may be extracted from the table or from a plot of the height H versus temperature T.

As shown in FIG. 4B, the temperature generally increases with increasing height. However, at vicinity of an interface 400 between the liquid 108 and gas 109, the temperature increases sharply before tapering off. The liquid 108 has a first thermal conductivity and the gas 109 has a second thermal conductivity different the thermal conductivity of the liquid 108. Therefore, by determining the point at which the temperature increases sharply or the inflection point, a position of the interface between the liquid 108 and the gas 109, and thus of the level of liquid 108 in the vessel 102, can be determined. The inflection point or the level of liquid 108 in the vessel can be estimated, for example, by performing an interpolation of all points (height, temperature) and determining a point where the temperature increase is maximum. For example, a derivative of the interpolation can be computed and a minimum of the derivative of the temperature versus height can be located. The height location of the minimum of the derivative of the temperature provides the level of the liquid 108 inside the vessel 102.

In some examples, including in at least one preferred example, optionally, the controller 106 is configured to determine the level of the liquid 108 inside the vessel 102 by i) determining a first temperature (for example, temperature T1) at a first height (for example, height H1) on the surface of the wall 103 where liquid 108 is present to provide a first data point, ii) determining a second temperature (for example, temperature T2) at a second height (for example height H2) on the surface of the wall 103 where gas 109 is present to provide a second data point, and iii) determining the level of the liquid 108 inside the vessel by interpolating the first data point and the second data point. A technical benefit may include using an interpolation technique that provides a relatively precise location of the level of the liquid based on a relationship between the height and temperature.

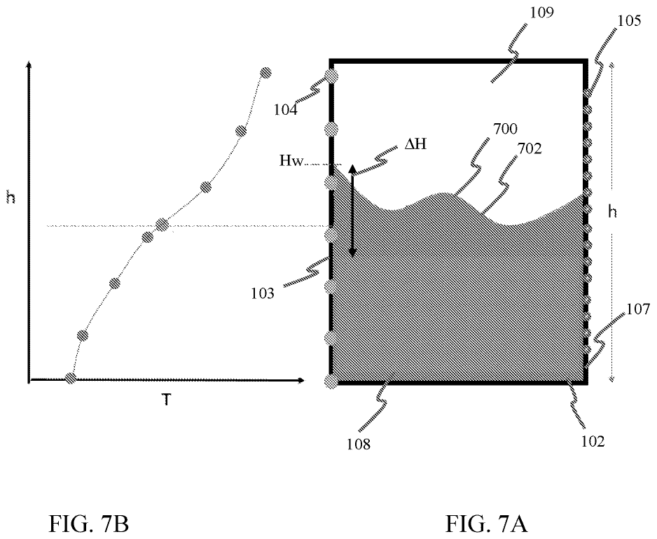

FIG. 7A is a schematic diagram of the vessel 102 having the plurality of spaced apart temperature sensors 104 for measuring temperature at different heights along the wall 103 of the vessel 102 to take into consideration the sloshing effect of the liquid 108 inside the vessel 102, according to an example. FIG. 7B is an exemplary points and graph of height versus temperature captured by the plurality of temperature sensors 104, according to an example. Similar to FIG. 4A, each of the plurality of temperature sensors 104 is positioned at a known height on the wall 103 of the vessel 102. Each of the plurality of temperature sensors 104 captures or detects a temperature at the height location on the wall 103 of the vessel 102. The temperatures detected by the plurality of temperature sensors 104 and corresponding height positions of the plurality of temperature sensors 104 are recorded in a table and/or plotted, as shown in FIG. 7B. In some examples, including in at least one preferred example, optionally, the controller 106 (shown in FIG. 1) in communication with the plurality of temperature sensors 104 is configured to determine a level of the liquid 108 inside the vessel 102 based on a relationship between the height H where the plurality of temperature sensors 104 are located and the temperature T measured by the plurality of temperature sensors 104.

In some examples, a sloshing of the liquid 108 inside the vessel 102 may occur. The sloshing may occur, for example, during the travel of the vehicle carrying the vessel 102 on an uneven road or during turns. The sloshing of the liquid 108 inside the vessel 102 is depicted in FIG. 7A as generating a wave pattern 702 at the surface 700 of the liquid 108. The wave pattern 702 at the surface 700 of the liquid 108 does not allow for a direct correspondence between the temperature and the height of the liquid 108 to be established. For example, although the surface 700 of the liquid 108 contacts the wall 103 of the vessel 102 at wave height Hw, this does not represent the true height of the liquid 108 inside the vessel 102. In addition, during the sloshing event, the temperature gradient along the wall 103 of the vessel 102 will be more distributed along a certain height AH of the vessel 102. In this case, the temperature measurement from the plurality of temperature sensors 104 can be used to determine the actual height level or fill level of liquid 108 inside the vessel 102. However, in the present case, determining the point at which the temperature increases sharply or the inflection point, may not be sufficient to determine a position of the interface between the liquid 108 and the gas 109, and thus of the level of liquid 108 in the vessel 102. Indeed, in a sloshing event, the inflection point of temperature versus height, shown in FIG. 7B, may not be steady enough and may be shifting in height (AH), for allowing a precise determination of the height or level of the liquid 108 in the vessel 102.

As a result, in a sloshing event, a machine learning (ML) algorithm can be used to take into consideration the shifting in height (AH) of the inflection point. The ML algorithm can be implemented, for example, by the controller 106 or by a processing device connected to the controller 106, or both. Prior to using the ML algorithm, a training data set of heights versus temperatures in a controlled environment can be used to train the ML algorithm to predict the height of the liquid 108 inside the vessel 102 given a measured set of temperatures. For example, in the controlled environment, the vessel 102 can be filled with the liquid 108 to a known height and the vessel 102 is then moved back and forth to generate the sloshing of the liquid 108 inside the vessel. The temperature sensors 104 would then provide a series of temperature measurements that would be correlated to heights of the liquid 108 inside the vessel. The heights would then be associated with the known height of the liquid 108 thus training the ML algorithm. These measurements can be repeated a plurality of times for various known levels of liquid 108 inside the vessel 102. In a real application, where the height or level if the liquid 108 inside the vessel 102 is not known, the ML algorithm can be used to extrapolate or interpolate temperature and height data points from the training data set where the height of the liquid is known. As a result, the ML algorithm can be used in situation where the height or level of the liquid 108 inside vessel cannot be determined directly using the interpolation method described in the above paragraphs with respect to FIGS. 4A and 4B. In addition, the training data can be used to generate a look-up table that correlates a series of temperature measurements to heights of the liquid 108 inside the vessel. The measured series of temperature may then be used to look-up the height of the liquid inside the vessel.

In an example, additional temperature sensors 105 can be provided on opposite wall 107 opposite the wall 103 of the vessel 102. The additional temperature sensors 105 can provide additional temperature measurements to increase the accuracy of the determination of the level or height of the liquid 108 inside the vessel 102 and to mitigate the effect of the surface 700 of the liquid 108 standing at an angle in certain situations.

Further signal processing can reduce the effect of running uphill or downhill. For example, two rows of temperature sensors 104 can be arranged on the same side or wall 103 of the vessel 102 but at different positions along the vehicle driving direction (longitudinal direction) to mitigate the effect of uphill and downhill driving, or to mitigate the effects of acceleration or braking of the vehicle, by comparing the signals from the two rows of temperature sensors 104. For example, by arranging temperature sensors near the ends of the vessel, the difference in temperature reading at the opposite ends can be used to determine that the vehicle is driving or parked uphill or downhill. The average height of the two may be used to determine the actual height.

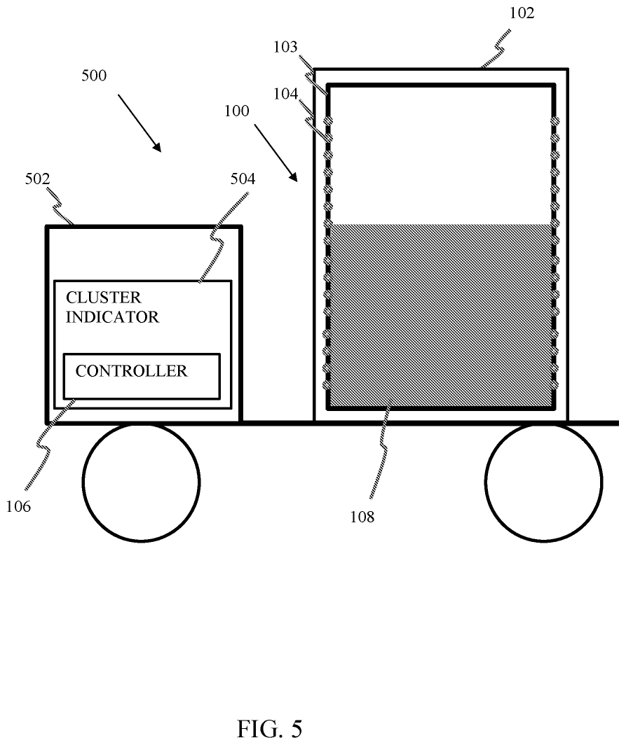

FIG. 5 is a schematic diagram of an exemplary vehicle 500 configured to carry the vessel 102, according to an example. According to a second aspect of the disclosure, the vehicle 500 includes a cabin 502 having a dashboard instrument cluster indicator 504, and the vessel 102 configured to carry the liquid 108 and the temperature-based level gauge 100. The temperature-based level gauge 100 includes a plurality of temperature sensors 104 disposed spaced apart along a height of a surface of the wall 103 of the vessel 102, each of the plurality of temperature sensors 104 being configured to measure a surface temperature of the vessel at a height location along the surface of the wall 103 of the vessel 102 and to output an electrical signal representative of the surface temperature. The temperature-based level gauge 100 also includes the controller 106 in communication with the plurality of temperature sensors 104 and the dashboard instrument cluster indicator 504. The controller 106 is configured to receive the electrical signal representative of the surface temperature from each of the plurality of temperature sensors 104. The controller 106 is configured to determine a level of the liquid 108 inside the vessel 102 based on surface temperatures measured by the plurality of temperature sensors 104. The second aspect of the disclosure may seek to measure a level of a liquid in a vessel carried by the vehicle and allowing, for example, the conductor or driver of the vehicle 500 to monitor the level of liquid during transport. As it must be appreciated, the vehicle 500 can include, but is not limited to, a truck, a trailer towed by a truck or a car, a van, a railed vehicle (e.g., a wagon pulled by a locomotive of a train), a ship (e.g., a tanker), a boat, an aircraft, a hovercraft, etc.

According to a third aspect of the disclosure, a method of measuring a level of a liquid in a vessel includes providing a plurality of temperature sensors 104 disposed spaced apart along a height of a surface of a wall 103 of the vessel 102. The method includes providing a controller 106 in communication with the plurality of temperature sensors 104, and measuring, with each of the plurality of temperature sensors 104, a surface temperature of the vessel 102 at a height location along the surface of the wall 103 of the vessel 102. The method further includes outputting a signal representative of the surface temperature, and receiving, by the controller 106, the signal representative of the surface temperature from each of the plurality of temperature sensors 104. The method further includes determining, by the controller 106, a level of liquid 108 inside the vessel 102 based on a variation of surface temperatures measured by the plurality of temperature sensors 104. This aspect of the disclosure may seek to measure a level of a liquid 108 (e.g., Cryogenic liquid) in a vessel 102 carried by the vehicle 500 and allowing, for example, the conductor or driver of the vehicle 500 to monitor the level of liquid during transport.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits. The controller 106 can be a computer system configured to receive the signal representative of the surface temperature from the plurality of temperature sensors 104. The controller 106 (computer system) can be configured to determine a level of liquid 108 inside the vessel 102 based on the surface temperatures measured by the plurality of temperature sensors 104.

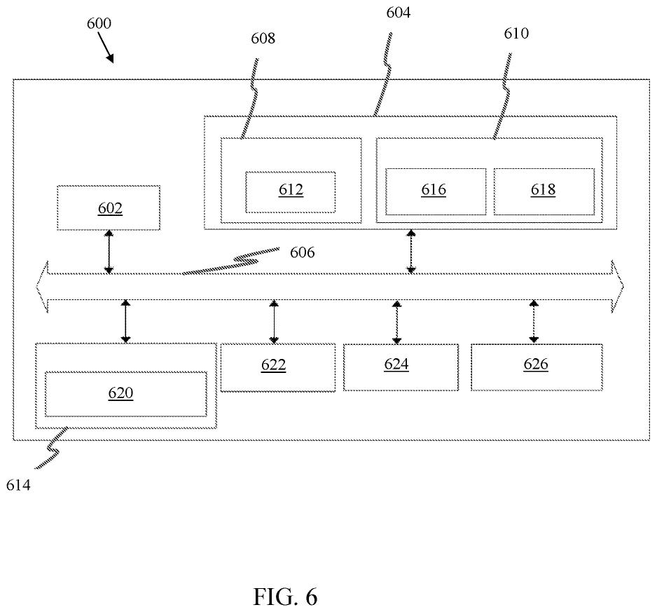

FIG. 6 is a schematic diagram of an exemplary computer system for implementing examples disclosed herein, according to an example. The computer system 600 is adapted to execute instructions from a computer-readable medium to perform these and/or any of the functions or processing described herein. The computer system 600 may be connected (e.g., networked) to other machines in a LAN, an intranet, an extranet, or the Internet. While only a single device is illustrated, the computer system 600 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein. The computer system 600 may include processing circuitry 602 (e.g., processing circuitry including one or more processor devices or control units), a memory 604, and a system bus 606. The computer system 600 may include at least one computing device having the processing circuitry 602. The system bus 606 provides an interface for system components including, but not limited to, the memory 604 and the processing circuitry 602. The processing circuitry 602 may include any number of hardware components for conducting data or signal processing or for executing computer code stored in memory 604. The processing circuitry 602 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 602 may further include computer executable code that controls operation of the programmable device.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilized with the systems and methods of this description. The memory 604 may be communicably connected to the processing circuitry 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures and which can be accessed by a computer or other machine with processing circuitry 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program 620 stored on a transitory or non-transitory computer-usable or computer-readable storage medium (e.g., single medium or multiple media), such as the storage device 614, which includes complex programming instructions (e.g., complex computer-readable program code) to cause the processing circuitry 602 to carry out actions described herein. Thus, the computer-readable program code of the computer program 620 can comprise software instructions for implementing the functionality of the examples described herein when executed by the processing circuitry 602. In some examples, the storage device 614 may be a computer program product (e.g., readable storage medium) storing the computer program 620 thereon, where at least a portion of a computer program 620 may be loadable (e.g., into a processor) for implementing the functionality of the examples described herein when executed by the processing circuitry 602. The processing circuitry 602 may serve as a controller or control system for the computer system 600 that is to implement the functionality described herein.

The computer system 600 may include an input device interface 622 configured to receive input and selections to be communicated to the computer system 600 when executing instructions, such as from a keyboard, mouse, touch-sensitive surface, etc. Such input devices may be connected to the processing circuitry 602 through the input device interface 622 coupled to the system bus 606 but can be connected through other interfaces, such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may include a communications interface 626 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software.

Although a specific order of method actions may be shown or described, the order of the actions may differ. In addition, two or more actions may be performed concurrently or with partial concurrence.
Example 1: A temperature-based level gauge for a vessel, including a plurality of temperature sensors disposed spaced apart along a height of a surface of a wall of the vessel, each of the plurality of temperature sensors being configured to measure a surface temperature of the vessel at a height location along the surface of the wall of the vessel and to output a signal representative of the surface temperature; and a controller in communication with the plurality of temperature sensors, the controller being configured to receive the signal representative of the surface temperature from the plurality of temperature sensors, wherein the controller is configured to determine a level of liquid inside the vessel based on the surface temperatures measured by the plurality of temperature sensors.
Example 2: The plurality of temperature sensors are disposed spaced apart along a height of an exterior surface of the wall of the vessel, opposite an interior surface of the wall that is in contact with a liquid within the vessel.
Example 3: The plurality of temperature sensors include a plurality of first temperature sensors disposed along a height of a first surface of the wall of the vessel, and a plurality of second temperature sensors disposed along a height of a second surface of the wall of the vessel, wherein the second surface is opposite to the first surface so as to take into consideration a sloshing of the liquid inside the vessel.
Example 4: The plurality of temperature sensors are regularly spaced apart along the height of the surface of the wall of the vessel.
Example 5: A spacing between two successive temperature sensors is selected according to a desired precision in determining a level of liquid inside the vessel.
Example 6: The vessel is a double-walled vessel and the plurality of temperature sensors are disposed spaced apart along the height of a surface of an interior wall of the double-walled vessel.
Example 7: The vessel is a double-walled vessel and the plurality of temperature sensors are disposed spaced apart along the height of a surface of an exterior wall of the double-walled vessel.
Example 8: The wall of the vessel has a round cross-section and the plurality of temperature sensors are disposed spaced apart along a perimeter of the surface of the wall having the round cross-section.
Example 9: The controller is in communication with the plurality of temperature sensors using electrical wires or the controller is in communication with the plurality of temperature sensors wirelessly.
Example 10: The controller is configured to determine the level of the liquid inside the vessel by i) determining a first temperature at a first height on the surface of the wall where liquid is present to provide a first data point, ii) determining a second temperature at a second height on the surface of the wall where gas is present to provide a second data point, and iii) determining the level of the liquid inside the vessel by interpolating the first data point and the second data point.
Example 11: The controller is configured to determine a level of the liquid inside the vessel based on a relationship between the height where the plurality of sensors are located and the temperature measured by the plurality of temperature sensors.
Example 12: A vehicle, including: a cabin having a dashboard instrument cluster indicator; a vessel configured to carry a liquid; and a temperature-based level gauge, including: a plurality of temperature sensors disposed spaced apart along a height of a surface of a wall of the vessel, each of the plurality of temperature sensors being configured to measure a surface temperature of the vessel at a height location along the surface of the wall of the vessel and to output an electrical signal representative of the surface temperature; and a controller in communication with the plurality of temperature sensors and the dashboard instrument cluster indicator, the controller being configured to receive the electrical signal representative of the surface temperature from each of the plurality of temperature sensors. The controller is configured to determine a level of the liquid inside the vessel based on surface temperatures measured by the plurality of temperature sensors.
Example 13: The plurality of temperature sensors are disposed spaced apart along a height of an exterior surface of the wall of the vessel, opposite an interior surface of the wall that is in contact with a liquid within the vessel.
Example 14: The plurality of temperature sensors comprise a plurality of first temperature sensors disposed along a height of a first surface of the wall of the vessel, and a plurality of second temperature sensors disposed along a height of a second surface of the wall of the vessel, wherein the first surface is opposite to the first surface so as to take into consideration a sloshing of the liquid inside the vessel.
Example 15: The plurality of temperature sensors are regularly spaced apart along the height of the surface of the wall of the vessel.
Example 16: A spacing between two successive temperature sensors is selected according to a desired precision in determining a level of liquid inside the vessel.
Example 17: The vessel is a double-walled vessel and the plurality of temperature sensors are disposed spaced apart along the height of a surface of an interior wall of the double-walled vessel.
Example 18: The vessel is a double-walled vessel and the plurality of temperature sensors are disposed spaced apart along the height of a surface of an exterior wall of the double-walled vessel.
Example 19: The wall of the vessel has a round cross-section and the plurality of temperature sensors are disposed spaced apart along a perimeter of the surface of the wall having the round cross-section.
Example 20: The controller is in communication with the plurality of temperature sensors using electrical wires or the controller is in communication with the plurality of temperature sensors wirelessly.
Example 21: The controller is configured to determine the level of the liquid inside the vessel by i) determining a first temperature at a first height on the surface of the wall where liquid is present to provide a first data point, ii) determining a second temperature at a second height on the surface of the wall where gas is present to provide a second data point, and iii) determining the level of the liquid inside the vessel by interpolating the first data point and the second data point.
Example 22: The controller is configured to determine a level of the liquid inside the vessel based on a relationship between the height where the plurality of sensors are located and the temperature measured by the plurality of temperature sensors.
Example 23: A method of measuring a level of a liquid in a vessel, including: providing a plurality of temperature sensors disposed spaced apart along a height of a surface of a wall of the vessel; providing a controller in communication with the plurality of temperature sensors; measuring, with each of the plurality of temperature sensors, a surface temperature of the vessel at a height location along the surface of the wall of the vessel; outputting a signal representative of the surface temperature; receiving, by the controller, the signal representative of the surface temperature from each of the plurality of temperature sensors; and determining, by the controller, a level of liquid inside the vessel based on a variation of surface temperatures measured by the plurality of temperature sensors.
Example 24: Providing the plurality of temperature sensors disposed spaced apart along the height of the surface of the wall of the vessel includes disposing the plurality of temperature sensors spaced apart along a height of an exterior surface of the wall of the vessel opposite an interior surface of the wall that is in contact with a liquid inside the vessel.
Example 25: Providing the plurality of temperature sensors disposed spaced apart along the height of the surface of the wall of the vessel includes disposing the plurality of temperature sensors on opposite sides on the surface of the wall of the vessel so as to take into consideration a sloshing of the liquid inside the vessel.
Example 26: Disposing the plurality of temperature sensors disposed spaced apart along the height of the surface of the wall of the vessel includes disposing the plurality of temperature sensors spaced apart regularly along the height of a surface of the wall of the vessel.
Example 27: Providing the plurality of temperature sensors disposed spaced apart along the height of the surface of the wall of the vessel includes disposing the plurality of temperature sensors spaced apart along the height of a surface of an inside wall of a double-walled vessel.
Example 28: Providing the plurality of temperature sensors disposed spaced apart along the height of the surface of the wall of the vessel comprises disposing the plurality of temperature sensors spaced apart along the height of a surface of an exterior wall of a double-walled vessel.
Example 29: The wall of the vessel has a round cross-section and the plurality of temperature sensors are disposed spaced apart along a perimeter of the surface of the wall having the round cross-section.
Example 30: The method according to claim 21, further including determining a first temperature corresponding to a temperature of a first height on the wall where the liquid is present to provide a first data point; determining a second temperature corresponding to a temperature of a second height on the wall where a gas is present to provide a second data point; and determining the level of the liquid inside the vessel by interpolating the first data point and the second data point.
Example 31: The plurality of temperature sensors includes a first set of temperature sensors disposed spaced apart along the height of the surface of a wall of the vessel and a second set of temperature sensors disposed spaced apart along the height of the surface of another wall of the vessel and spaced apart from the first set temperature sensors.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms.

These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A temperature-based level gauge for a vessel, comprising:
a plurality of temperature sensors disposed spaced apart along a height of a surface of a wall of the vessel, each of the plurality of temperature sensors being configured to measure a surface temperature of the vessel at a height location along the surface of the wall of the vessel and to output a signal representative of the surface temperature; and
a controller in communication with the plurality of temperature sensors, the controller being configured to receive the signal representative of the surface temperature from the plurality of temperature sensors;
wherein the controller is configured to determine a level of a liquid inside the vessel based on the surface temperature measured by the plurality of temperature sensors.

2. The temperature-based level gauge according to claim 1, wherein the plurality of temperature sensors are disposed spaced apart along a height of an exterior surface of the wall of the vessel, opposite an interior surface of the wall that is in contact with the liquid within the vessel.

3. The temperature-based level gauge according to claim 1, wherein the plurality of temperature sensors comprise a plurality of first temperature sensors disposed along a height of a first surface of the wall of the vessel, and a plurality of second temperature sensors disposed along a height of a second surface of the wall of the vessel, wherein the second surface is opposite to the first surface so as to take into consideration a sloshing of the liquid inside the vessel.

4. The temperature-based level gauge according to claim 1, wherein the plurality of temperature sensors are regularly spaced apart along the height of the surface of the wall of the vessel.

5. The temperature-based level gauge according to claim 1, wherein a spacing between two successive temperature sensors is selected according to a desired precision in determining a level of the liquid inside the vessel.

6. The temperature-based level gauge according to claim 1, wherein the vessel is a double-walled vessel and the plurality of temperature sensors are disposed spaced apart along the height of a surface of an interior wall of the double-walled vessel.

7. The temperature-based level gauge according to claim 1, wherein the vessel is a double-walled vessel and the plurality of temperature sensors are disposed spaced apart along the height of a surface of an exterior wall of the double-walled vessel.

8. The temperature-based level gauge according to claim 1, wherein the wall of the vessel has a round cross-section and the plurality of temperature sensors are disposed spaced apart along a perimeter of the surface of the wall having the round cross-section.

9. The temperature-based level gauge according to claim 1, wherein the controller is in communication with the plurality of temperature sensors through electrical wires or the controller is in communication with the plurality of temperature sensors wirelessly.

10. The temperature-based level gauge according to claim 1, wherein the controller is configured to determine the level of the liquid inside the vessel by i) determining a first temperature at a first height on the surface of the wall where the liquid is present to provide a first data point, ii) determining a second temperature at a second height on the surface of the wall where gas is present to provide a second data point, and iii) determining the level of the liquid inside the vessel by interpolating the first data point and the second data point.

11. The temperature-based level gauge according to claim 1, wherein the controller is configured to determine a level of the liquid inside the vessel based on a relationship between the height where the plurality of temperature sensors are located and the surface temperature measured by the plurality of temperature sensors.

12. A vehicle, comprising
a cabin having a dashboard instrument cluster indicator;
a vessel configured to carry a liquid; and
a temperature-based level gauge, comprising:
a plurality of temperature sensors disposed spaced apart along a height of a surface of a wall of the vessel, each of the plurality of temperature sensors being configured to measure a surface temperature of the vessel at a height location along the surface of the wall of the vessel and to output an electrical signal representative of the surface temperature; and
a controller in communication with the plurality of temperature sensors and the dashboard instrument cluster indicator, the controller being configured to receive the electrical signal representative of the surface temperature from each of the plurality of temperature sensors;
wherein the controller is configured to determine a level of the liquid inside the vessel based on a surface temperatures measured by the plurality of temperature sensors.

13. The vehicle according to claim 12, wherein the plurality of temperature sensors are disposed spaced apart along a height of an exterior surface of the wall of the vessel, opposite an interior surface of the wall that is in contact with the liquid within the vessel.

14. The vehicle according to claim 12, wherein the plurality of temperature sensors comprise a plurality of first temperature sensors disposed along a height of a first surface of the wall of the vessel, and a plurality of second temperature sensors disposed along a height of a second surface of the wall of the vessel, wherein the first surface is opposite to the first surface so as to take into consideration a sloshing of the liquid inside the vessel.

15. The vehicle according to claim 12, wherein the plurality of temperature sensors are regularly spaced apart along the height of the surface of the wall of the vessel.

16. The vehicle according to claim 12, wherein a spacing between two successive temperature sensors is selected according to a desired precision in determining a level of the liquid inside the vessel.

17. The vehicle according to claim 12, wherein the vessel is a double-walled vessel and the plurality of temperature sensors are disposed spaced apart along the height of a surface of an interior wall of the double-walled vessel.

18. The vehicle according to claim 12, wherein the vessel is a double-walled vessel and the plurality of temperature sensors are disposed spaced apart along the height of a surface of an exterior wall of the double-walled vessel.

19. The vehicle according to claim 12, wherein the wall of the vessel has a round cross-section and the plurality of temperature sensors are disposed spaced apart along a perimeter of the surface of the wall having the round cross-section.

20. The vehicle according to claim 12, wherein the controller is in communication with the plurality of temperature sensors through electrical wires or the controller is in communication with the plurality of temperature sensors wirelessly.

21. The vehicle according to claim 12, wherein the controller is configured to determine the level of the liquid inside the vessel by i) determining a first temperature at a first height on the surface of the wall where the liquid is present to provide a first data point, ii) determining a second temperature at a second height on the surface of the wall where gas is present to provide a second data point, and iii) determining the level of the liquid inside the vessel by interpolating the first data point and the second data point.

22. The vehicle according to claim 12, wherein the controller is configured to determine a level of the liquid inside the vessel based on a relationship between the height where the plurality of temperature sensors are located and the surface temperature measured by the plurality of temperature sensors.

23. A method of measuring a level of a liquid in a vessel, comprising:
providing a plurality of temperature sensors disposed spaced apart along a height of a surface of a wall of the vessel;
providing a controller in communication with the plurality of temperature sensors;
measuring, with each of the plurality of temperature sensors, a surface temperature of the vessel at a height location along the surface of the wall of the vessel;
outputting a signal representative of the surface temperature;
receiving, by the controller, the signal representative of the surface temperature from each of the plurality of temperature sensors; and
determining, by the controller, a level of a liquid inside the vessel based on a variation of surface temperatures measured by the plurality of temperature sensors.

24. The method according to claim 23, wherein providing the plurality of temperature sensors disposed spaced apart along the height of the surface of the wall of the vessel comprises disposing the plurality of temperature sensors spaced apart along a height of an exterior surface of the wall of the vessel opposite an interior surface of the wall that is in contact with the liquid inside the vessel.

25. The method according to claim 23, wherein providing the plurality of temperature sensors disposed spaced apart along the height of the surface of the wall of the vessel comprises disposing the plurality of temperature sensors on opposite sides on the surface of the wall of the vessel so as to take into consideration a sloshing of the liquid inside the vessel.

26. The method according to claim 23, wherein providing the plurality of temperature sensors disposed spaced apart along the height of the surface of the wall of the vessel comprises disposing the plurality of temperature sensors spaced apart regularly along the height of a surface of the wall of the vessel.

27. The method according to claim 23, wherein providing the plurality of temperature sensors disposed spaced apart along the height of the surface of the wall of the vessel comprises disposing the plurality of temperature sensors spaced apart along the height of a surface of an inside wall of a double-walled vessel.

28. The method according to claim 23, wherein providing the plurality of temperature sensors disposed spaced apart along the height of the surface of the wall of the vessel comprises disposing the plurality of temperature sensors spaced apart along the height of a surface of an exterior wall of a double-walled vessel.

29. The method according to claim 23, wherein the wall of the vessel has a round cross-section and the plurality of temperature sensors are disposed spaced apart along a perimeter of the surface of the wall having the round cross-section.

30. The method according to claim 23, further comprising:
determining a first temperature corresponding to a temperature of a first height on the wall where the liquid is present to provide a first data point;
determining a second temperature corresponding to a temperature of a second height on the wall where a gas is present to provide a second data point; and
determining the level of the liquid inside the vessel by interpolating the first data point and the second data point.

31. The method according to claim 23, wherein the plurality of temperature sensors includes a first set of temperature sensors disposed spaced apart along the height of the surface of a wall of the vessel and a second set of temperature sensors disposed spaced apart along the height of the surface of another wall of the vessel and spaced apart from the first set of temperature sensors.
